(19) United States
(12) Patent Application Publication
(10) Pub. No.: US 2020/0314501 A1
(43) Pub. Date: Oct. 1, 2020

(54) CAPTIONING DIGITAL MEDIA WITH CONTEXT DATA

(71) Applicant: Lenovo (Singapore) Pte. Ltd., Singapore (SG)

(72) Inventors: Russell Speight VanBlon, Raleigh, NC (US); Nathan J. Peterson, Oxford, NC (US); John Carl Mese, Cary, NC (US); Mark Patrick Delaney, Raleigh, NC (US)

(21) Appl. No.: 16/366,638

(22) Filed: Mar. 27, 2019

(51) Int. Cl. H04N 21/488; H04N 21/462; H04N 21/81

(52) U.S. Cl. CPC H04N 21/4884; H04N 21/8133; H04N 21/4622

(57) ABSTRACT

One embodiment provides a method, including: creating, using an information handling device, digital media content; capturing, substantially during the creating, context data associated with the digital media content; and captioning the digital media content with the context data, wherein the captioning comprises automatically captioning without additional user input. Other aspects are described and claimed.

### BACKGROUND

Users may be able to utilize information handling devices (“devices”), for example smart phones, tablets, laptop and person computers, other consumer electronic devices, and the like, to create and/or capture different types of digital media. For example, users may capture pictures and/or videos, create digital artwork, write text documents (e.g., essays, social media posts, text messages and/or emails, etc.), and the like. Once created, a user may thereafter send the digital media content to another user or upload it to an online platform for other users to view and comment.

### BRIEF SUMMARY

In summary, one aspect provides a method, comprising: creating, using an information handling device, digital media content; capturing, substantially during the creating, context data associated with the digital media content; and captioning the digital media content with the context data.

Another aspect provides an information handling device, comprising: a processor; a memory device that stores instructions executable by the processor to: create digital media content; capture, substantially during the creating, context data associated with the digital media content; and captioning the digital media content with the context data.

A further aspect provides a product, comprising: a storage device that stores code, the code being executable by a processor and comprising: code that creates digital media content; code that captures, substantially during the creating, context data associated with the digital media content; and code that captions the digital media content with the context data.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example method of captioning digital media content with context data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

After creating various types of digital media content, users may transmit that content to a variety of different destinations. For example, a user may upload a captured image to a social media platform for other individuals to view. As another example, a user may directly send a video to another individual via text message, email, etc. Generally, various items of contextual data are associated with each content creation (e.g., location of creation, individuals associated with or proximate to the creation, events associated with or proximate to the creation, etc.). Oftentimes, these contextual items go unnoticed.

Conventionally, a user could manually supplement the digital media content with an explanation of the surrounding context to apprise other individuals of its existence. For example, an image of two individuals singing a song may be uploaded to a social media platform. A user may tag the image with the description, “Bob Marley blasting on the radio!” As another example, an image of a group of individuals standing in front of a car may be sent from one user to another with the added description, “Hanging out downtown with Jack and Bill at the car show”. However, if not described immediately, users oftentimes forget the context surrounding their creation. Additionally, users may not be fully aware of certain types of context associated with their creation (e.g., a building an image was captured in, the identity of other users in a video, etc.). Furthermore, providing a description for a piece of content may take time, which some users may not have.

Accordingly, an embodiment provides a method for dynamically captioning digital media content with contextual data. In an embodiment, digital media content may be created using a device. An embodiment may then capture certain types of contextual data associated with the digital media content and thereafter automatically, without additional user input, caption the digital media content with the captured contextual data. In an embodiment, the caption may supplement the digital media content and may be viewable alongside the digital media content. Such a method may enrich created content by automatically apprising other individuals over context surrounding the content creation.

The illustrated example embodiments will be best understood by reference to the figures. The following description is intended only by way of example, and simply illustrates certain example embodiments.

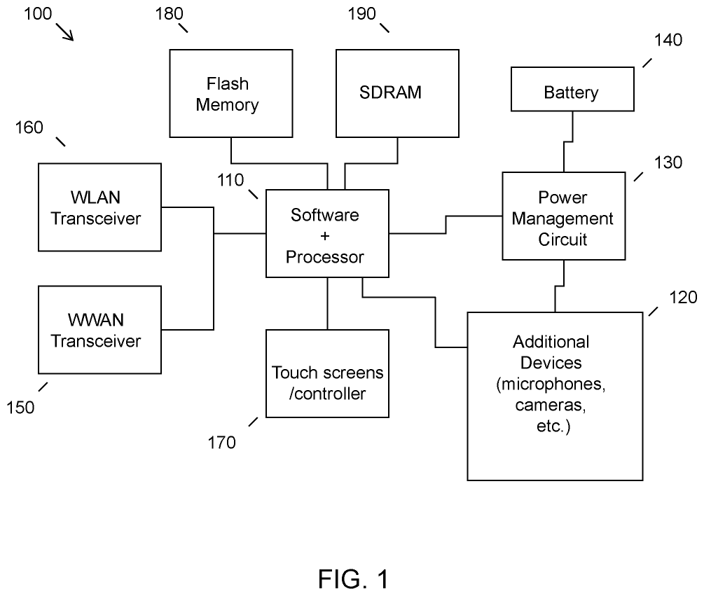

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, devices 120 are commonly included, e.g., an image sensor such as a camera, audio capture device such as a microphone, motion sensor such as an accelerometer or gyroscope, etc. System 100 often includes one or more touch screens 170 for data input and display/rendering. System 100 also typically includes various memory devices, for example flash memory 180 and SDRAM 190.

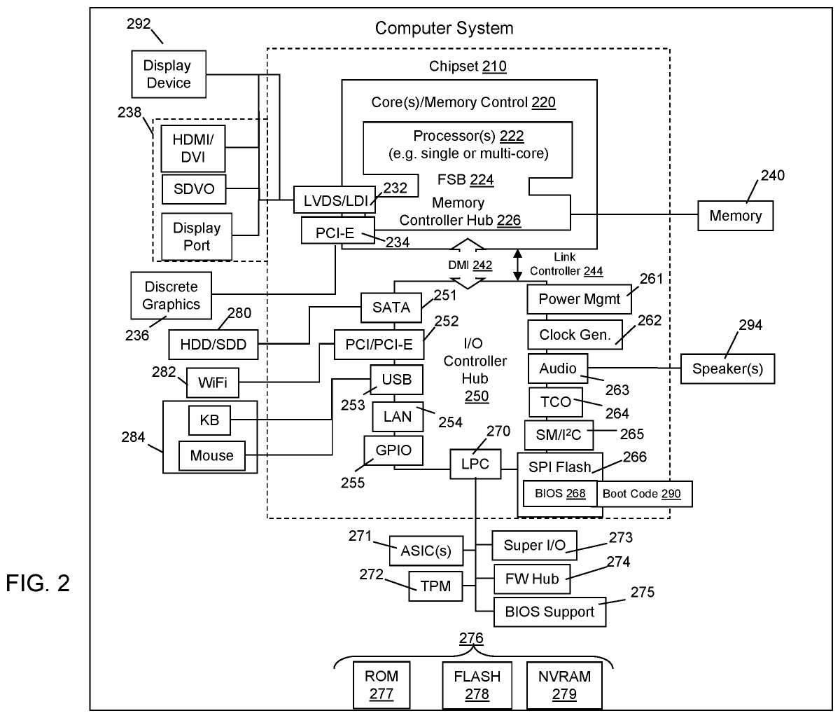

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a low voltage differential signaling (LVDS) interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices such as smart phones, tablets, laptops, personal computers, and/or other electronic devices that are capable of capturing contextual data associated with an item of digital media content. For example, the circuitry outlined in FIG. 1 may be implemented in a tablet or smart phone embodiment, whereas the circuitry outlined in FIG. 2 may be implemented in a laptop.

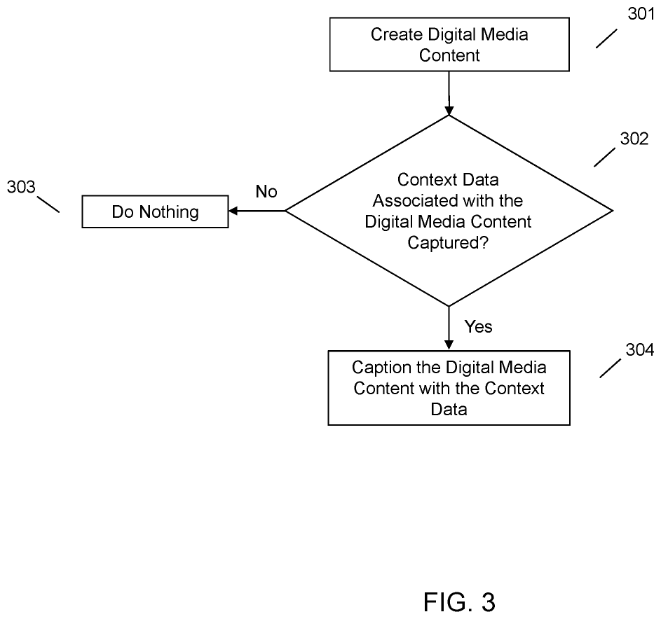

Referring now to FIG. 3, an embodiment may dynamically augment an article of digital media content with contextual data. At 301, an embodiment may create digital media content (“content”) using a device. In the context of this application, content may refer to virtually any type of content a user may create using a device. For example, content may refer to an image, a video, a song, a graphic, a piece of text, a message, a social media post, a combination thereof, and the like. Content may be created or captured by a user via the utilization of one or more content creating or capturing devices operatively coupled to the device (e.g., a touch-sensitive display screen, a stylus, an audio capture device, an image capture device, etc.).

At 302, an embodiment may capture context data associated with the content. In the context of this application, context data may refer to virtually any type of contextual data associated with the media content. For instance, context data may refer to ambient audio data (e.g., to identify words, phrases, or sounds spoken or detected during creation of the content, etc.), location data (e.g., to identify a location where the content was created, etc.), wireless signature data (e.g., to identify other devices located proximate to the content creating device, etc.), calendar data (e.g., to identify events that the content may be related to or created during, etc.), and the like.

In an embodiment, the context data may be captured substantially simultaneously during the content creation. For example, when an embodiment receives an indication to capture an image, an embodiment may simultaneously capture context data associated with the image (e.g., a location that the image was captured, etc.). Alternatively, an embodiment may continuously capture context data associated with the device and associate context data captured a predetermined amount of time before and/or after the creation of the content (e.g., 5 seconds before and after the creation of the content, etc.).

If an embodiment is unable to capture, at 302, context data associated with the content, an embodiment may, at 303, take no additional action. More particularly, a user may store or transmit the content without any context data attached. Conversely, responsive to capturing, at 302, context data associated with the content, an embodiment may, at 304, caption the content with the context data.

In an embodiment, the captioning may involve providing a phrase that accompanies the content and that describes the context or describes the relationship of the context to the content. In an embodiment, the phrase may be a predetermined phrase stored in an accessible database (e.g., stored locally on the device, remotely on another device or server, etc.). For example, responsive to identifying that a particular Beetles song was playing in a captured video, an embodiment may provide the caption “Rocking out to the Beetles!” As another example, responsive to identifying that a user captured an image downtown, an embodiment may provide the caption “hanging out downtown”. In yet another example, an embodiment may identify the presence of other devices known to be associated with the user's friends and include this information in the caption. For example, a caption for an image taken downtown may be “hanging out downtown with Charlie and John”. It is important to note that the foregoing examples are not limiting and that other phrases, not explicitly mentioned here, may be also be utilized. Additionally, captioning, as used in the context of this application, is not limited to providing text-based phrases, but may also include captioning using images, emoticons, a combination thereof, and the like.

In an embodiment, the selection of the phrase may be based on the type of context data detected. For instance, if an embodiment detects location-based context data, an embodiment may access a list of location-based context data phrases (e.g., “hanging out downtown”, “downtown tonight”, “having fun downtown”, etc.). An embodiment may thereafter select (e.g., randomly, etc.) a phrase from the list. In an embodiment, if multiple types of context data are detected then an embodiment may select a phrase from a list of multi-context data phrases. For example, if an embodiment detects location-based context data and also identity data for proximate devices known to be associated with a user's friends, an embodiment may provide one of the following captions: “Hanging out downtown with friends”, “Hanging out downtown with Jack and Jim”, “The gang downtown on a Friday night”. In an embodiment, the phrases in the lists may be initially programmed by a manufacturer and thereafter adjusted by a user.

In an embodiment, the captioning of the content with the context data may occur automatically. More particularly, an embodiment may caption the content without any additional user input. In an embodiment, the captioning may occur substantially when the content is created. Alternatively, an embodiment may caption the content when the content is transmitted to another destination. For example, if a user were to upload an image to a social media platform, an embodiment may automatically provide a caption for the image upon upload of the image. As another example, if a user were to send an image to another individual via text message, an embodiment may provide a caption for the image when the image is selected to be transmitted.

In an embodiment, the captioned context data may be attached to the content as metadata. In this regard, when the context data is transmitted to another destination (e.g., another device, a storage space, etc.), the captioned context may be transported along with it. Thereafter, if the content was uploaded to a social media platform from the other destination then the stored caption may automatically be provided.

In an embodiment, responsive to receiving the caption, a user may approve the caption, decline the caption, or edit the caption. For example, a notification query may be provided alongside the caption asking the user whether it is acceptable to include with the content. Responsive to receiving a positive answer, an embodiment may attach the caption to the content. Conversely, responsive to receiving a negative answer, an embodiment may disregard the caption and/or provide a new caption for consideration. For example, an embodiment may provide the user with a drop-down list of alternative context-based captions that they may select from. Additionally or alternatively, a user may edit the caption. For example, instead of having the broad caption “Hanging out downtown” a user may want to specify who they were downtown with, e.g., “Hanging out downtown with Jack and Jim”.

The various embodiments described herein thus represent a technical improvement to conventional captioning techniques. Using the techniques described herein, an embodiment may create content using a device. An embodiment may then capture context data associated with the content and thereafter automatically caption the content with the context data. In an embodiment, the caption may be provided alongside the content when the content is sent to another individual or place, uploaded to a website or social media platform, etc. Such a method may allow a user to automatically enrich content with contextual data that they may not have thought to include with the presentation of their content.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, a system, apparatus, or device (e.g., an electronic, magnetic, optical, electromagnetic, infrared, or semiconductor system, apparatus, or device) or any suitable combination of the foregoing. More specific examples of a storage device/medium include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

1. A method, comprising:
creating, using an information handling device, digital media content;
capturing, substantially during the creating, context data associated with the digital media content, wherein the capturing comprises identifying at least one other device, belonging to another user, associated with the digital media content; and
captioning the digital media content with the context data, wherein the captioning comprises including an indication of the another user in a caption associated with the digital media content.

2. The method of claim 1, wherein the digital media content comprises at least one item selected from the group consisting of an image, a video, a document, a message, and a social media post.

3. The method of claim 1, wherein the capturing comprises capturing the context data utilizing data selected from the group consisting of location data, wireless signature data, calendar data, and proximate device identity data.

4. The method of claim 1, wherein the captioning comprises automatically captioning without additional user input.

5. The method of claim 1, wherein the captioning comprises captioning responsive to transmitting the digital media content to another device.

6. The method of claim 1, wherein the captioning comprises captioning responsive to uploading the digital media content to an online platform.

7. The method of claim 1, wherein the captioning comprises attaching a phrase describing the context data.

8. The method of claim 7, wherein the phrase comprises a plurality of words selected from an accessible data store.

9. The method of claim 1, further comprising attaching the captioned context data to the digital media content as metadata.

10. The method of claim 1, further comprising receiving, from a user, editing input to the captioned digital media content.

11. An information handling device, comprising:
a processor;
a memory device that stores instructions executable by the processor to:
create digital media content;
capture, substantially during the creating, context data associated with the digital media content, wherein the capturing comprises identifying at least one other device, belonging to another user, associated with the digital media content; and
captioning the digital media content with the context data, wherein the captioning comprises including an indication of the another user in a caption associated with the digital media content.

12. The information handling device of claim 11, wherein the digital media content comprises at least one item selected from the group consisting of an image, a video, a document, a message, and a social media post.

13. The information handling device of claim 11, wherein the instructions executable by the processor to capture comprise instructions executable by the processor to capture the context data utilizing data selected from the group consisting of location data, wireless signature data, calendar data, and proximate device identity data.

14. The information handling device of claim 11, wherein the instructions executable by the processor to caption comprise instructions executable by the processor to automatically caption without additional user input.

15. The information handling device of claim 11, wherein the instructions executable by the processor to caption comprise instructions executable by the processor to caption responsive to transmitting the digital media content to another device.

16. The information handling device of claim 11, wherein the instructions executable by the processor to caption comprise instructions executable by the processor to caption responsive to uploading the digital media content to an online platform.

17. The information handling device of claim 11, wherein the instructions executable by the processor to caption comprise instructions executable by the processor to attach a phrase describing the context data.

18. The information handling device of claim 11, wherein the instructions are further executable by the processor to attach the captioned context data to the digital media content as metadata.

19. The information handling device of claim 11, wherein the instructions are further executable by the processor to receive, from a user, editing input to the captioned digital media content.

20. A product, comprising:
a storage device that stores code, the code being executable by a processor and comprising:
code that creates digital media content;
code that captures, substantially during the creating, context data associated with the digital media content, wherein the capturing comprises identifying at least one other device, belonging to another user, associated with the digital media content; and
code that captions the digital media content with the context data, wherein the captioning comprises including an indication of the another user in a caption associated with the digital media content.
